(19) United States
(12) Patent Application Publication
(10) Pub. No.: US 2024/0134262 A1
(43) Pub. Date: Apr. 25, 2024

(54) PROJECTOR

(71) Applicant: TOYODA GOSEI CO., LTD., Kiyosu-shi (JP)

(72) Inventor: Masato TAKEUCHI, Kiyosu-shi (JP)

(21) Appl. No.: 18/489,063

(22) Filed: Oct. 17, 2023

(30) Foreign Application Priority Data
Oct. 24, 2022 (JP) 2022-170484
Sep. 14, 2023 (JP) 2023-150227

(51) Int. Cl. G03B 21/20

(52) U.S. Cl. CPC G03B 21/2053; G03B 21/208

(57) ABSTRACT

A projector includes a pattern portion including a pattern to be projected onto a projection area, a light source unit that irradiates the pattern with projected light, and a projection lens unit including a projection lens that enlarges a design of the pattern in a region irradiated with the projected light and projects the design onto the projection area to form a projected image thereon. The projected image formed on the projection area is changed by switching the region of the pattern irradiated with the projected light or by changing an in-plane angle of the pattern.

### CROSS-REFERENCE TO RELATED APPLICATIONS

The present patent application claims the priority of Japanese patent application Nos. 2022/170484 and 2023/150227 filed on Oct. 25, 2022 and Sep. 15, 2023, respectively, and the entire contents of Japanese patent application Nos. 2022/170484 and 2023/150227 are hereby incorporated by reference.

### TECHNICAL FIELD

The present invention relates to a projector.

### BACKGROUND ART

A lighting device for vehicle is known which has a light guide means to guide light emitted from a light source to an illumination surface in the interior of a vehicle, and a pattern panel that is provided between the light guide means and the illumination surface, has a predetermined pattern formed thereon and transmits light from the light guide means to project the pattern onto the illumination surface (see, e.g., Patent Literature 1).

In the lighting device, the image of light projected onto surfaces in the vehicle interior can be changed by replacing the pattern panel with another pattern panel according to the user's preference.

### CITATION LIST

### Patent Literature

Patent Literature 1: JP 2014/40194 A

### SUMMARY OF INVENTION

The known lighting device for vehicle may have a problem in that changing the image to be projected requires time and effort since the image cannot be changed unless the pattern panel is replaced.

It is an object of the invention to provide a projector that can easily switch between projected images.

An aspect of the invention provides a projector as defined below.

(1) A projector, comprising:
a pattern portion comprising a pattern to be projected onto a projection area;
a light source unit that irradiates the pattern with projected light; and
a projection lens unit comprising a projection lens that enlarges a design of the pattern in a region irradiated with the projected light and projects the design onto the projection area to form a projected image thereon, wherein the projected image formed on the projection area is changed by switching the region of the pattern irradiated with the projected light or by changing an in-plane angle of the pattern.

(2) The projector defined in (1) above, wherein the light source unit comprises a plurality of light sources each comprising at least one light-emitting element, and wherein the region of the pattern irradiated with the projected light is switched by independently changing an emission state of the plurality of light sources included in the light source unit.

(3) The projector defined in (2) above, further comprising a control unit that controls the emission state the plurality of light sources included in the light source unit, wherein the pattern portion, the light source unit and the projection lens unit are housed in one housing.

(4) The projector defined in (3) above, further comprising a condenser lens unit comprising a plurality of condenser lenses that are arranged for each of the light sources to collect the projected light output from the light source unit.

(5) The projector defined in (4) above, further comprising a partition member that separates between the light sources.

(6) The projector defined in (2) above, wherein the projection lens unit projects a plurality of the projection images onto the same location in the projection area.

(7) The projector defined in (2) above, wherein the projection lens unit projects a plurality of the projection images onto different locations in the projection area.

(8) The projector defined in (2) above, wherein the control unit continuously controls turning on and off of the light-emitting element to switch the projected image and project the projected image dynamically onto the projection area.

(9) The projector defined in (2) above, wherein when the light source comprises a plurality of the light-emitting elements, the control unit controls turning on and off of the light-emitting elements to cause at least one of an increase/decrease in brightness of the projected image and color change of the projected image.

(10) The projector defined in (2) above, wherein a plurality of the projected images are sequentially projected onto the projection area by controlling turning on and off of the light-emitting elements by the control unit to display an image changing with time, and wherein the plurality of projected images are projected in such a manner that each projected image is faded in and faded out and timing of projecting each of the plurality of the projected images partially coincides with timings of projecting the projected images projected therebefore and thereafter.

(11) The projector defined in (10) above, wherein the image changing with time comprises an image comprising a portion changing in a flickering manner, or an image comprising a portion moving in a specific direction.

(12) The projector defined in (1) above, wherein, by moving the pattern portion relative to the light source unit, the region of the pattern irradiated with the projected light is switched or the in-plane angle of the pattern is changed.

(13) The projector defined in (12) above, wherein, by moving the pattern portion while fixing the light source unit in the projector, the region of the pattern irradiated with the projected light is switched or the in-plane angle of the pattern is changed.

(14) The projector defined in (12) above, wherein, by moving the light source unit while fixing the pattern portion in the projector, the region of the pattern irradiated with the projected light is switched.

(15) The projector defined in (13) above, wherein the in-plane angle of the pattern is changed by rotating the pattern portion.

(16) The projector defined in (12) above, wherein, by sliding the pattern portion relative to the light source unit, the region of the pattern irradiated with the projected light is switched.

(17) A projector, comprising:
a pattern portion comprising a pattern to be projected onto a projection area;
a light source unit that comprises a plurality of light sources each comprising at least one light-emitting element, each of the light sources outputting projected light to a different region of the pattern;
a projection lens unit comprising a plurality of projection lenses that are installed corresponding to the different region of the pattern, and that enlarges and projects opposing one of the different region of the pattern to form a projected image on the projection area; and
a control unit that controls turning on and off of the light-emitting element of the light source unit to switch a plurality of the projected image corresponding to the different region of the pattern.

(18) The projector defined in (17) above, further comprising a condenser lens unit comprising a plurality of condenser lenses that are arranged for each of the light sources to collect the projected light output from the light source unit.

(19) The projector defined in (17) above, further comprising a partition member that separates between the light sources.

(20) The projector defined in (17) above, wherein the control unit continuously controls turning on and off of the light-emitting element to switch the projected image and project the projected image dynamically onto the projection area.

### Advantageous Effects of Invention

According to the invention, it is possible to easily switch between projected images.

### BRIEF DESCRIPTION OF DRAWINGS

FIG. 1 is an exploded view showing an example of a projector in the first embodiment.

FIG. 2A is a front view showing the example of the projector in the first embodiment.

FIG. 2B is an example of a block diagram of the projector in the first embodiment.

FIG. 3A is an example of a top view showing the projector in the first embodiment.

FIG. 3B is an example of a left side view showing the projector in the first embodiment.

FIG. 3C is an example of a cross-sectional view when a cross section taken along a line A-A in

FIG. 3A is viewed in the arrow direction.

FIG. 4 is a diagram illustrating the interior of a vehicle and showing examples of installation location and projection position of the projector in the first embodiment.

FIG. 5A is an example of an explanatory cross-sectional view showing a pattern portion of the projector in the first embodiment.

FIG. 5B is a top view showing an example of the pattern portion in the first embodiment.

FIG. 5C is a top view showing an example of the pattern portion in a modification of the first embodiment.

FIG. 6A shows an example of a projected image projected by a first light source of the projector in the first embodiment.

FIG. 6B shows an example of a projected image projected by a second light source of the projector in the first embodiment.

FIG. 6C shows an example of a projected image projected by a third light source of the projector in the first embodiment.

FIG. 7A shows an example of a dynamic projected image projected by the first light source of the projector in the first embodiment.

FIG. 7B shows an example of a dynamic projected image projected by the second light source of the projector in the first embodiment.

FIG. 7C shows an example of a dynamic projected image projected by the third light source of the projector in the first embodiment.

FIG. 7D is a diagram illustrating an example of when plural projected images projected by the first to third light sources of the projector in the first embodiment are superimposed.

FIG. 8A is a diagram illustrating an example of a light source having four light-emitting elements in the second embodiment.

FIG. 8B is a diagram illustrating an example of the light source having three light-emitting elements in the second embodiment.

FIG. 9A is a diagram illustrating an example of a light source unit having two light sources in the second embodiment.

FIG. 9B is a diagram illustrating an example of the light source unit having four light sources in the second embodiment.

FIGS. 10A to 10C are explanatory diagrams illustrating examples of brightness level of the projected image in the second embodiment.

FIG. 11A shows an example of a portion of the projected image projected by the first light source of the projector in the third embodiment.

FIG. 11B shows an example of a portion of the projected image projected by the second light source of the projector in the third embodiment.

FIG. 11C shows an example of a portion of the projected image projected by the third light source of the projector in the third embodiment.

FIG. 12 is an example of a timing chart showing output timings of the light-emitting elements in the third embodiment.

FIG. 13A shows an example of the projected image projected by the first light source of the projector in the third embodiment.

FIG. 13B shows an example of the projected image projected by the second light source of the projector in the third embodiment.

FIG. 13C shows an example of the projected image projected by the third light source of the projector in the third embodiment.

FIGS. 14A and 14B are schematic diagrams each illustrating a state in which a first projector, a second projector and a third projector, which constitute the projector in the fourth embodiment, project the projected image onto a projection area.

FIG. 15A is a perspective view showing the first projector in the fourth embodiment.

FIG. 15B is a vertical cross-sectional view showing the first projector in the fourth embodiment.

FIG. 16A is a perspective view showing the internal construction of a projector in the fifth embodiment.

FIGS. 16B and 16C are explanatory diagrams showing the internal movement of the projector in the fifth embodiment.

FIG. 17A is a perspective view showing the internal construction of an alternative projector in the fifth embodiment.

FIGS. 17B and 17C are explanatory diagrams showing the internal movement of the alternative projector in the fifth embodiment.

### DESCRIPTION OF EMBODIMENTS

### First Embodiment

(General Configuration of a Projector 1)

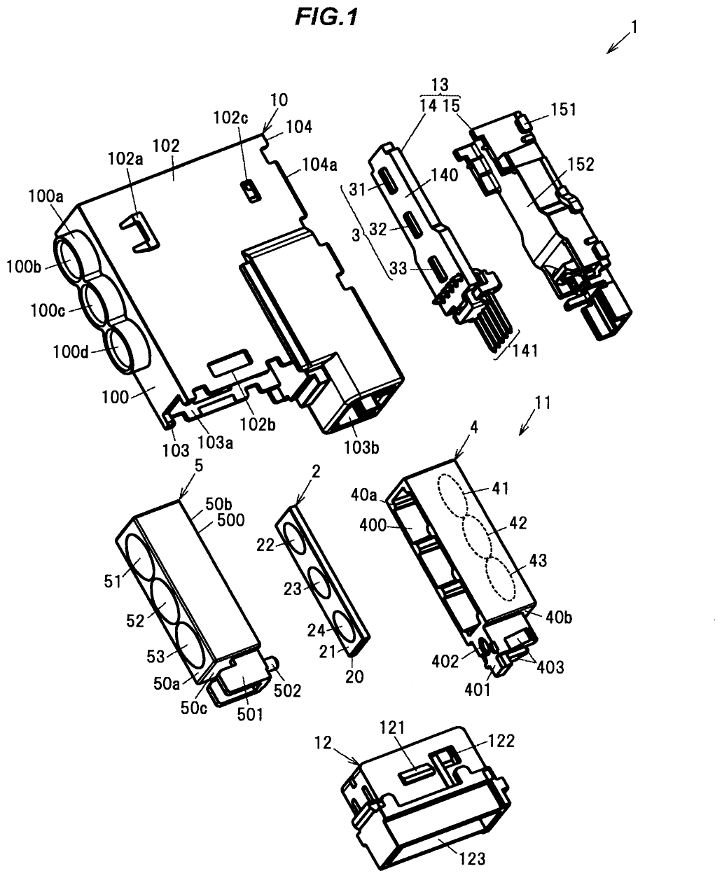

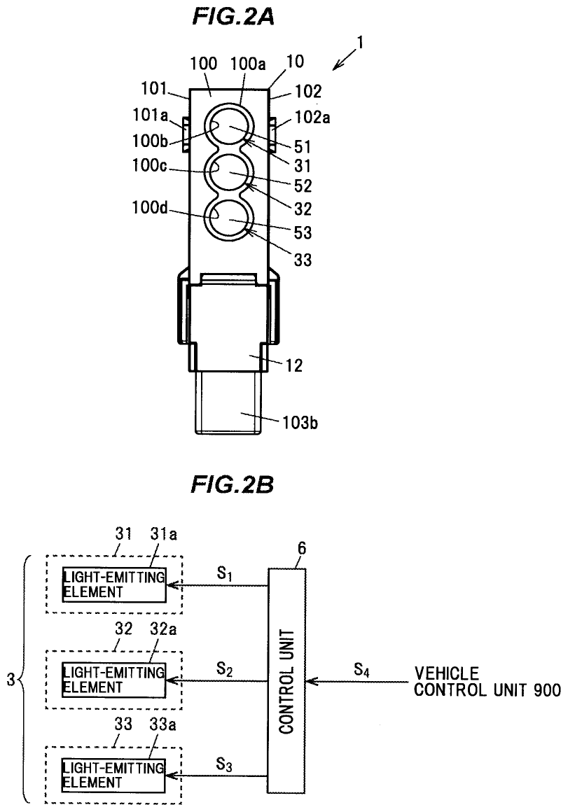

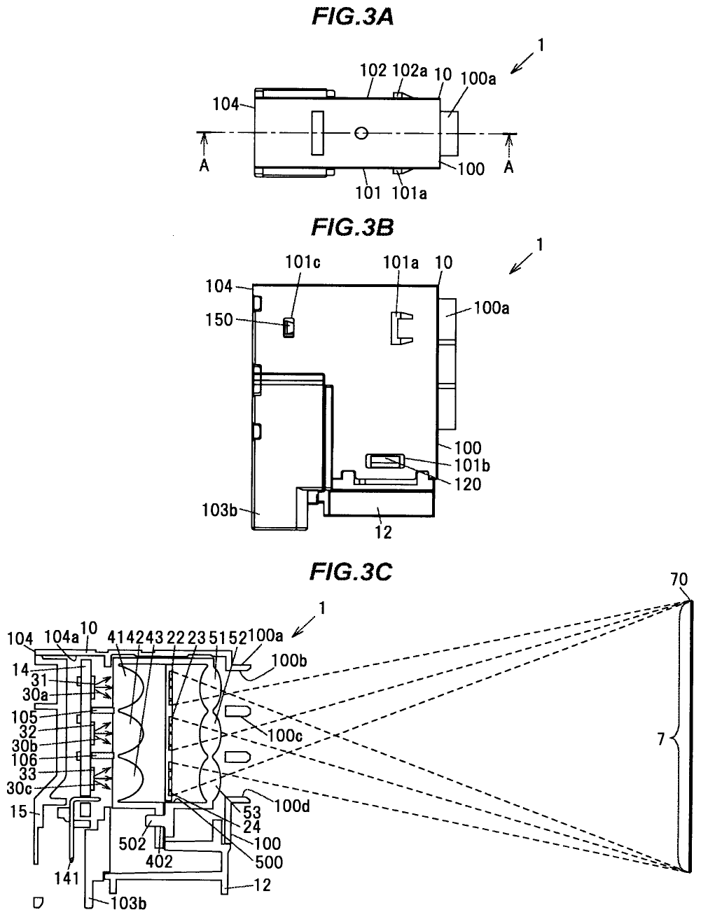

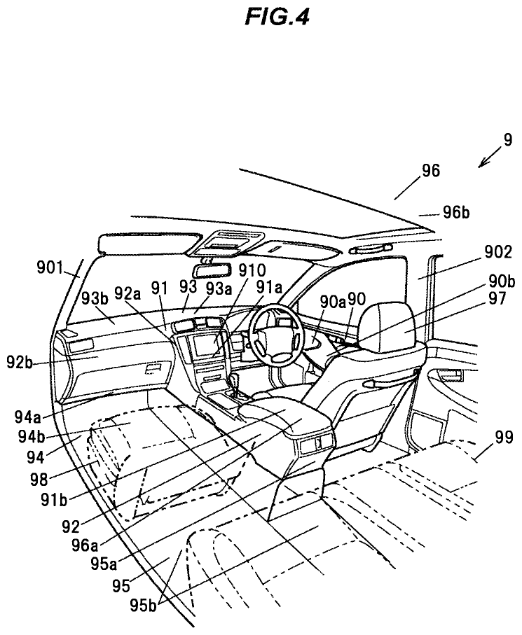

FIG. 1 is an exploded view showing an example of a projector in the first embodiment. FIG. 2A is a front view showing the example of the projector in the first embodiment, and FIG. 2B is an example of a block diagram of the projector. FIG. 3A is an example of a top view showing the projector in the first embodiment, FIG. 3B is an example of a left side view showing the projector, and FIG. 3C is an example of a cross-sectional view when a cross section taken along line A-A in FIG. 3A is viewed in the arrow direction. FIG. 4 is a diagram illustrating the interior of a vehicle and showing examples of installation location and projection position of the projector in the first embodiment. In each drawing of the embodiments described below, a scale ratio or shape may be different from an actual ratio or shape. In addition, in FIG. 2A, flows of main signals and information are indicated by arrows.

As shown in FIGS. 1 to 3C, the projector 1 in the first embodiment is generally composed of a pattern portion 2 having a pattern (FIG. 21 to be projected onto a projection area 7, a light source unit 3 that has plural light sources each composed of at least one light-emitting element and is configured such that the light sources output projected light 30 respectively to different regions of the pattern 21, a projection lens unit 5 having plural projection lenses that are provided so as to correspond to the different regions of the pattern and form a projected image 70 in the projection area 7 by enlarging and projecting the different regions of the pattern that face the projection lenses, and a control unit 6 that controls turning on and off of the light-emitting elements of the light source unit 3 to switch between plural projected images 70 which correspond to the different regions of the pattern 21.

As shown in FIG. 1, the pattern portion 2 in the first embodiment has first to third pattern regions 22 to 24 as plural regions of the pattern 21, as an example. The first to third pattern regions 22 to 24 have different designs as an example, but are not limited thereto.

As shown in FIG. 2B, the light source unit 3 in the first embodiment has first to third light sources 31 to 33 as the plural light sources, as an example. The first to third light sources 31 to 33 are provided so as to correspond to the first to third pattern regions 22 to 24 of the pattern portion 2. The first to third light sources 31 to 33 output projected lights 30a to 30c, but when there is no need to distinguish the light sources, light output from the light source unit 3 is referred to as the projected light 30.

As shown in FIG. 1, the projector 1 in the first embodiment includes the projection lens unit 5 having first to third projection lens 51 to 53 that are provided so as to correspond to the first to third pattern regions 22 to 24 and enlarge and project the first to third pattern regions 22 to 24 onto the projection area 7, as an example.

As shown in FIG. 1, the projector 1 also includes a condenser lens unit 4 having plural condenser lenses that are arranged for each of the light sources to collect the projected light 30 output from the light source unit 3.

As shown in FIG. 1, the projector 1 in the first embodiment includes the condenser lens unit 4 having first to third condenser lenses 41 to 43 that are arranged respectively for the first to third light sources 31 to 33. When the light-emitting element is configured to output the highly directional projected light 30, the projector 1 can be configured not to include the condenser lens unit 4, as a modification.

Installation location and projection position of the projector 1 As shown in FIG. 4, the projector 1 is arranged inside a vehicle 9 and its projection position is an interior component of the vehicle 9, as an example. In particular, the projector 1 is arranged on a door 90, an instrument panel 91, a floor box 92, a bathtub 93, a floor 94 below a driver's seat 97 and a front passenger seat 98, a floor 95 below a rear seat 99, or a ceiling 96, etc., as an example.

In case of arranging, e.g., on the door 90, the projector 1 is arranged in a pocket of an armrest or inside a raised portion at the front of the door 90. Inside the raised portion at the front of the door 90 here is in the vicinity of a connecting portion to the instrument panel 91 on the driver's seat 97 side or the front passenger seat 98 side.

In case that the projector 1 is arranged at an installation location 90a which is inside a door trim of the door 90, the projection area 7 is a projection position 90b such as an ornament panel at an upper portion the door 90, as an example, as shown in FIG. 4. The door 90 refers to the door on the driver's seat 97 side in FIG. 4, but it is just an example and the door 90 may be a door on the front passenger seat 98 side or a door on the rear seat 99 side.

In case that the projector 1 is arranged at an installation location 91a which is inside the instrument panel 91, the projection area 7 is a projection position 91b such as a lid portion of the floor box 92, as an example.

In case that the projector 1 is arranged at an installation location 92a such as a portion of the instrument panel 91 on a side of a display device 910 or a portion on a side of a vent of an air conditioner, the projection area 7 is a projection position 92b such as an ornament panel in front of the front passenger seat 98, as an example.

In case that the projector 1 is arranged at an installation location 93a which is inside the bathtub 93 below the windshield or inside a protruding portion around the display device 910, the projection area 7 is a projection position 93b in front of the front passenger seat 98, as an example.

In case that the projector 1 is arranged at an installation location 94a which is inside a lower portion of the instrument panel 91 in front of the driver's seat 97 or the front passenger seat 98, the projection area 7 is a projection position 94b such as the floor 94 at the driver's seat 97 or the front passenger seat 98, as an example.

In case that the projector 1 is arranged at an installation location 95a at the back of the floor box 92, the projection area 7 is a projection position 95b such as the floor 95 at the rear seat 99, as an example.

Furthermore, in case that the projector 1 is arranged at an installation location 96a inside the lid portion of the floor box 92, the projection area 7 is a projection position 96b which is the ceiling 96, as an example.

The projection area 7 is not limited to the above examples, and the interior of the vehicle 9 such as an A-pillar 901 or a B-pillar 902 can be the projection position. Furthermore, the projector 1 can be arranged at a lower portion of the door and used as a courtesy lamp of which projection position is a road surface.

(Configuration of a Housing 10)

As shown in FIG. 1, the projector 1 includes a housing 10, a first unit 11 integrally including optical system parts, and a second unit 13 integrally including the light source unit 3, etc. The first unit 11 has the pattern portion 2, the condenser lens unit 4, the projection lens unit 5, and a first cover 12. The second unit 13 has a substrate 14 and a second cover 15.

The housing 10 is formed using a resin material and has a long and thin box shape. The housing 10 has a cylinder portion 100a composed of three connected cylinders and provided on a front surface 100. The housing 10 also has a first insertion opening 103a and a connector portion 103b which are provided on a lower surface 103 and into which the first unit 11 is inserted, and a second insertion opening 104a which is provided on a back surface 104 and into which the second unit 13 is inserted.

The cylinder portion 100a has first to third lens openings 100b to 100d which are openings of the cylinders. The first to third projection lens 51 to 53 are exposed inside the first to third lens openings 100b to 100d. Since the first to third lens openings 100b to 100d are openings which are independent of each other, the projection lenses therein are less likely to be visible to occupants. In this regard, the first to third lens openings 100b to 100d may be formed as one continuous opening, or may have a shape other than the circular shape.

As shown in FIGS. 3A and 3B, a left-side claw portion 101a, a lower-side fitting opening 101b and an upper-side fitting opening 101c are provided on a left side surface 101 of the housing 10. Likewise, as shown in FIG. 1, a right-side claw portion 102a, a lower-side fitting opening 102b and an upper-side fitting opening 102c are provided on a right side surface 102 of the housing 10.

The left-side claw portion 101a and the right-side claw portion 102a are fitted into openings provided on an attachment target object. The lower-side fitting openings 101b and 102b are to be fitted with fitting claws 120 and 121 of the first cover 12. The upper-side fitting openings 101c and 102c are to be fitted with fitting claws 150 and 151 of the second cover 15.

A connector of the vehicle 9 is attached to the connector portion 103b. Connector pins 141 of the substrate 14 are exposed in the connector portion 103b.

The substrate 14 is a long and narrow printed circuit board. The substrate 14 has the connector pins 141 at an end. The substrate 14 is inserted into an attachment opening 152 of the second cover 15 and is thereby attached thereto.

(Configuration of the Pattern Portion 2)

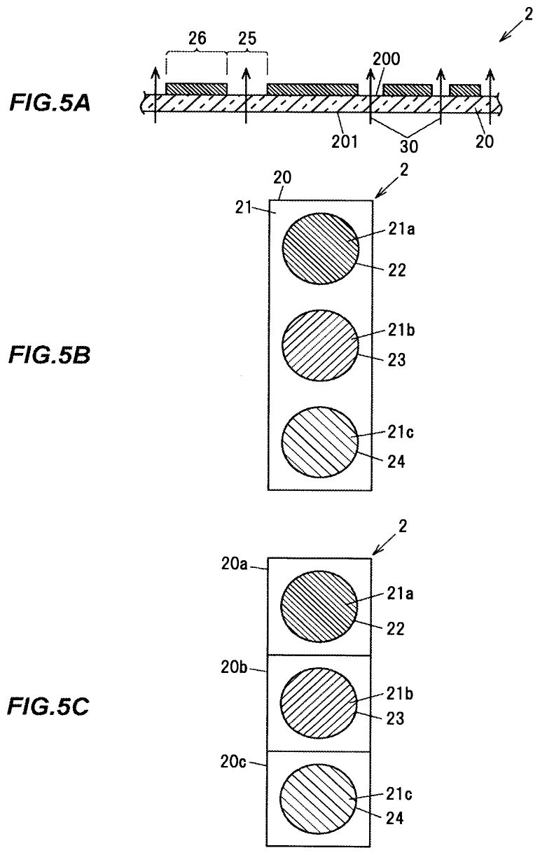

FIG. 5A is an example of an explanatory cross-sectional view showing the pattern portion of the projector in the first embodiment, FIG. 5B is a top view showing an example of the pattern portion, and FIG. 5C is a top view showing an example of the pattern portion in a modification. In the following description, designs formed by a transmissive region 25 and a light-shielding region 26 will be described as an example, but it is not limited thereto as long as the projected image 70 can be formed.

As shown in FIG. 5A, the pattern portion 2 has a long and narrow plate-shaped transparent substrate 20 formed of a transparent resin material transparent to light. The pattern 21 is formed on a front surface 200 of the transparent substrate 20, but may be formed on a back surface 201 or may be formed on the front surface 200 and the back surface 201. The pattern 21 has first to third pattern regions 22 to 24 which have a circular shape as an example but may have a rectangular shape or a combination of plural shapes, and it is not limited thereto.

The first to third pattern regions 22 to 24 are aligned in a straight line at equal intervals, as an example. The first to third pattern regions 22 to 24 have first to third designs 21a to 21c. The first to third pattern regions 22 to 24 are projected onto the projection area 7 and form the projected image 70.

The projected images 70 of the first to third pattern regions 22 to 24 are projected images 70a to 70c (described later), but when there is no need to distinguish therebetween, all are referred to as the projected image 70. The designs of the projected images 70a to 70c are projected as enlarged images of the first to third designs 21a to 21c of the first to third pattern regions 22 to 24 and are similar to the first to third designs 21a to 21c, hence, the respective designs of the projected images are referred to as the first to third designs 21a to 21c.

In the first to third pattern regions 22 to 24, the first to third designs 21a to 21c are formed by the transmissive region 25 and the light-shielding region 26, as an example. The transmissive region 25 is a region that transmits the projected light 30 output from the light source unit 3. The light-shielding region 26 is a region that does not transmit the projected light 30 or has a lower transmittance than the transmissive region 25. The light-shielding region 26 may also be formed in a region outside the first to third pattern regions 22 to 24.

The pattern 21 is formed by two regions which are the transmissive region 25 and the light-shielding region 26 as an example, but it is not limited thereto. The pattern 21 may be colored, or the light-shielding region area 26 may have regions with plural transmittances, or a combination thereof may be used.

As an example, the light-shielding region 26 may be formed by etching a metal film formed on the front surface 200 of the transparent substrate 20, or may be formed by applying a light-shielding paint by printing, etc., or may be formed by applying a light-shielding paint to the front surface 200 and then removing the paint at a location corresponding to the transmissive region 25 by laser. However, it is not limited thereto.

As shown in FIG. 5B, the first to third pattern regions 22 to 24 have the first to third designs 21a to 21c that are different designs. As a modification, the pattern portion 2 may be formed by aligning first to third pattern plates 20a to 20c on which the first to third pattern regions 22 to 24 are formed, as shown in FIG. 5C.

(Configuration of the Light Source Unit 3)

The light source unit 3 in the first embodiment has the first to third light sources 31 to 33 as the plural light sources, as an example. However, the number of light sources is not limited thereto as long as the number is plural as described later.

In the light source unit 3, the first light source 31 has a light-emitting element 31a, the second light source 32 has a light-emitting element 32a and the third light source 33 has a light-emitting element 33a as an example, but it is not limited thereto. That is, the light source may be composed of plural light-emitting elements instead of one light-emitting element, and the number of light-emitting elements may be different for each light source.

As shown in FIG. 1, the light-emitting elements 31a to 33a are arranged on a surface 140 of the substrate 14 and aligned in a straight line at equal intervals. The light-emitting elements 31a to 33a are LED (Light Emission Diode) elements that output white projected light 30 as an example, but are not limited thereto and may be LD (Laser Diode) elements, etc. In addition, the light-emitting elements 31a to 33a output the projected lights 30 of the same color as an example, but it is not limited thereto and at least one of the light-emitting elements 31a to 33a may output the projected light 30 of a different color.

The projector 1 includes a partition member that separates between the light sources. Since the light source unit 3 in the first embodiment has the first to third light sources 31 to 33, a first partition member 105 between the first light source 31 and the second light source 32 and a second partition member 106 between the second light source 32 and the third light source 33 are provided as the partition member.

As an example, the first partition member 105 and the second partition member 106 are formed in a plate shape using a resin material and are provided inside the second insertion opening 104a. However, the shape of the first partition member 105 and the second partition member 106 is not limited to the plate shape and may be a cylindrical shape surrounding the light source so that the projected lights 30 output from the first to third light sources 31 to 33 are not mixed. In addition to the first partition member 105 and the second partition member 106, the partition member may also be provided between the first condenser lens 41 and the second condenser lens 42 and between the second condenser lens 42 and the third condenser lens 43.

(Configuration of the Condenser Lens Unit 4)

As shown in FIG. 1, the condenser lens unit 4 is formed using a resin material and has a long and thin box shape. The first to third condenser lenses 41 to 43 are integrally formed in an opening 400 provided on a front surface 40a of the condenser lens unit 4. The first to third condenser lenses 41 to 43 are formed as convex lenses using a resin material, as an example.

As shown in FIG. 3C, the first condenser lens 41 is configured to collect the spreading projected light 30a output from the light-emitting element 31a of the first light source 31 onto the first pattern region 22. The second condenser lens 42 is configured to collect the spreading projected light 30b output from the light-emitting element 32a of the second light source 32 onto the second pattern region 23. The third condenser lens 43 is configured to collect the spreading projected light 30c output from the light-emitting element 33a of the third light source 33 onto the third pattern region 24.

The first to third condenser lenses 41 to 43 collect and guide the projected lights 30a to 30c to the first to third pattern regions 22 to 24 arranged to face the first to third condenser lenses 41 to 43 and thus have the same curvature. However, it is not limited thereto, and the curvature may be different depending on the position of the pattern region or may be different according to the curvature of the projection lens unit 5.

As shown in FIG. 1, the condenser lens unit 4 has a protruding portion 401 that protrudes from a side surface 40b. The protruding portion 401 has a hole portion 402 which is a circular hole, and claw portions 403. The claw portions 403 are provided on two opposite surfaces of the protruding portion 401.

(Configuration of the Projection Lens Unit 5)

The projection lens unit 5 is configured to project plural projected images 70 onto the same location in the projection area 7. The projection lens unit 5 is formed using a resin material and has a long and thin box shape, as an example. As shown in FIGS. 1 and 3C, the projection lens unit 5 has an opening 500 on a back surface 50b. The pattern portion 2 is attached to the opening 500.

As shown in FIG. 1, the first to third projection lens 51 to 53 are integrally formed on a front surface 50a of the projection lens unit 5. The first to third projection lens 51 to 53 are configured as biconvex lenses to magnify and project the collected projected light 30. The first to third projection lens 51 to 53 have different curvatures so that the plural projected images 70 are projected onto the same location.

As shown in FIG. 3C, the first projection lens 51 forms a projected image 70a by projecting the projected light 30a of the first light source 31, which is collected by the first condenser lens 41 and reaches the first projection lens 51 through the first pattern region 22, onto the projection area 7. The projected image 70a is an enlarged image of the first design 21a of the first pattern region 22.

In the first embodiment, since the projection lenses are arranged in a row, the second projection lens 52 located in the center is the reference and the projected image 70b is projected in front of the second projection lens 52. Thus, the first projection lens 51, which is located above the second projection lens 52 on the paper of FIG. 3C, downwardly shifts and projects the projected image 70a. That is, the first projection lens 51 is configured so that the projected image 70a is projected onto the same location as the projected image 70b projected by the second projection lens 52.

As shown in FIG. 3C, the second projection lens 52 forms a projected image 70b by projecting the projected light 30b of the second light source 32, which is collected by the second condenser lens 42 and reaches the second projection lens 52 through the second pattern region 23, onto the projection area 7. The projected image 70b is an enlarged image of the second design 21b of the second pattern region 23.

As shown in FIG. 3C, the third projection lens 53 forms a projected image 70c by projecting the projected light 30c of the third light source 33, which is collected by the third condenser lens 43 and reaches the third projection lens 53 through the third pattern region 24, onto the projection area 7. The projected image 70c is an enlarged image of the third design 21c of the third pattern region 24.

The third projection lens 53, which is located below the second projection lens 52 on the paper of FIG. 3C, upwardly shifts and projects the projected image 70c. That is, the third projection lens 53 is configured so that the projected image 70c is projected onto the same location as the projected image 70b projected by the second projection lens 52.

In this manner, the first to third projection lens 51 to 53 have curvatures that are symmetrical with respect to the second projection lens 52.

The projection lens unit 5 has a protruding portion 501 that protrudes from a side surface 50c. The protruding portion 501 has a columnar portion 502 that is inserted into the hole portion 402 of the condenser lens unit 4. The pattern portion 2, the condenser lens unit 4 and the projection lens unit 5 are positioned and integrated by inserting the columnar portion 502 into the hole portion 402.

The integrated condenser lens unit 4, pattern portion 2 and projection lens unit 5 are inserted into an attachment opening 123 of the first cover 12. This insertion causes the claw portions 403 of the condenser lens unit 4 to be fitted into fitting openings 122, thereby integrating the condenser lens unit 4, the pattern portion 2, the projection lens unit 5 and the first cover 12. In this regard, the fitting openings 122 of the first cover 12 are provided on opposite sides so as to correspond to the claw portions 403 provided on the opposite side surfaces of the condenser lens unit 4.

(Configuration of the Control Unit 6)

The control unit 6 is, e.g., a microcomputer composed of a CPU (Central Processing Unit) performing calculation and processing, etc., of the acquired data according to a stored program, and a RAM (Random Access Memory) and a ROM (Read Only Memory) as semiconductor memories, etc. The ROM stores, e.g., a program for operation of the control unit 6. The RAM is used as, e.g., a storage area to temporarily store calculation results, etc. The control unit 6 is arranged on the substrate 14.

As shown in FIG. 2B, the control unit 6 is electrically connected to the light-emitting elements 31a to 33a. The control unit 6 is configured to control turning on and off of the light-emitting elements 31a to 33a by outputting first to third control signals S₁ to S₃. For example, the light-emitting elements 31a to 33a turn on when receiving an input of the first to third control signals S₁ to S₃ and are off with no input. The first to third control signals S₁ to S₃ are PWM (Pulse Width Modulation) signals as an example, but are not limited thereto.

As an example, the control unit 6 switches between the projected images 70a to 70c in response to vehicle information S₄ acquired from a vehicle control unit 900 that comprehensively controls the vehicle 9. As an example, the vehicle information S₄ is information about an occupant getting in, start of the driving system, and start of driving. As an example, the control unit 6 controls to project the projected image 70a based on the first pattern region 22 when an occupant gets in the vehicle, projects the projected image 70b based on the second pattern region 23 when the driving system is started, and projects the projected image 70c based on the third pattern region 24 when driving is started. However, it is not limited thereto.

The control unit 6 switches between the projected images 70a to 70c based on the vehicle information S₄, but it is not limited thereto. Switching may be performed based on an operation on a switch for switching or based on an operation on an icon, etc., displayed on the display device 910, and it is not limited thereto. The occupant can switch the projected image 70 according to his/her feeling by operating a switch or an icon, etc.

Switching Between the Projected Images 70a to 70c

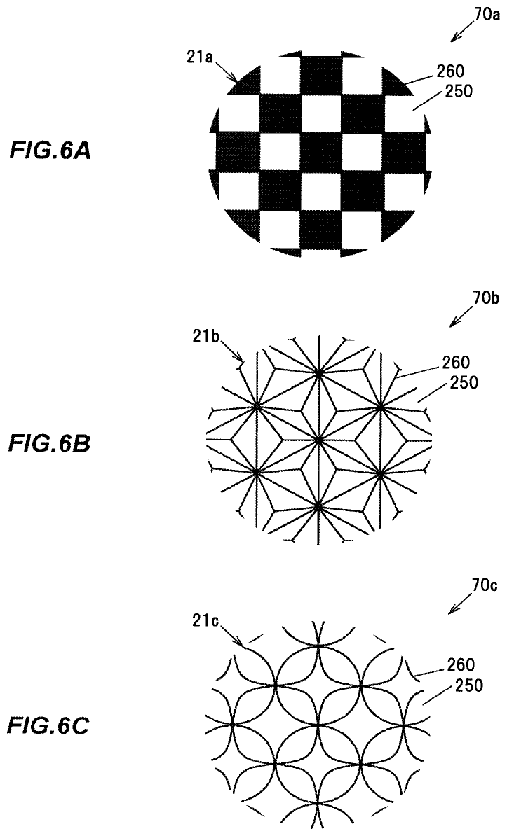

FIG. 6A shows an example of the projected image projected by the first light source of the projector in the first embodiment, FIG. 6B shows an example of the projected image projected by the second light source, and FIG. 6C shows an example of the projected image projected by the third light source.

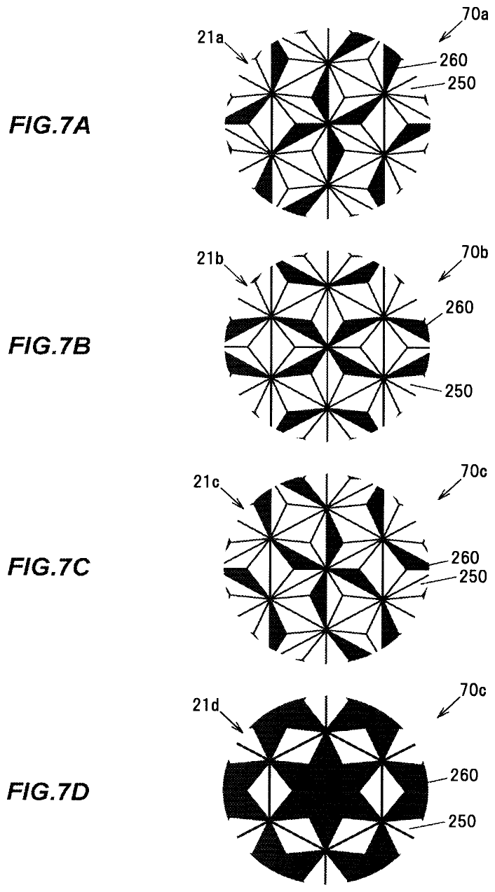

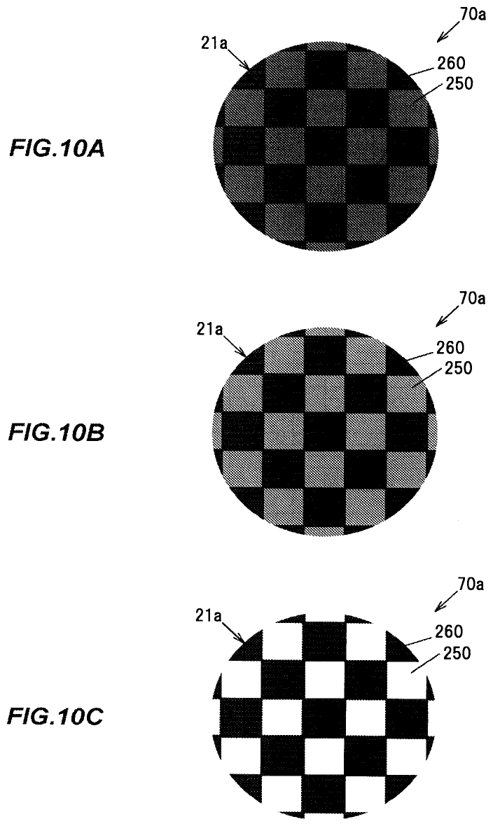

FIGS. 6A to 6C described here and FIGS. 7A to 7D and 10A to 10C described later show projected images 70a to 70d that are projected by the projector 1 from directly above the projection area 7 and have a circular shape, as an example. The projected images 70a to 70d change from the circular shape to an elliptical shape depending on tilt of the projector 1 relative to the projected area 7. The shapes of the projected images 70a to 70d correspond to the shapes of the pattern regions or the shape of the lens openings of the housing 10 through which the projected light 30 exits.

In the projected images 70a to 70c in FIGS. 6A to 6C, colorless part on the paper is a light-transmitted image 250 formed by the projected light 30 transmitted through the transmissive region 25 of the pattern 21, and black part is a light-shielded image 260 formed by blocking the projected light 30 by the light-shielding region 26. The projected images 70a to 70c in FIGS. 6A to 6C are formed by the light-transmitted image 250 and the light-shielded image 260 as described above, but are not limited thereto.

The first light source 31 turns on the light-emitting element 31a and outputs the projected light 30a, based on the first control signal S₁ output from the control unit 6. The projected light 30a exits from the first lens opening 100b through the first condenser lens 41, the first pattern region 22 and the first projection lens 51 and forms the projected image 70a, which is an enlarged image of the first design 21a, onto the projection area 7, as shown in FIG. 6A.

The second light source 32 turns on the light-emitting element 32a and outputs the projected light 30b, based on the second control signal S₂ output from the control unit 6. The projected light 30b exits from the second lens opening 100c through the second condenser lens 42, the second pattern region 23 and the second projection lens 52 and forms the projected image 70b, which is an enlarged image of the second design 21b, onto the projection area 7, as shown in FIG. 6B.

The third light source 33 turns on the light-emitting element 33a and outputs the projected light 30c, based on the third control signal S₃ output from the control unit 6. The projected light 30c exits from the third lens opening 100d through the third condenser lens 43, the third pattern region 24 and the third projection lens 53 and forms the projected image 70c, which is an enlarged image of the third design 21c, onto the projection area 7, as shown in FIG. 6C.

The control unit 6 can switch between the projected images 70a to 70c by outputting the first to third control signals S₁ to S₃, as described above.

The projected images 70a to 70c that are projected dynamically FIG. 7A shows an example of a dynamic projected image projected by the first light source of the projector in the first embodiment, FIG. 7B shows an example of a dynamic projected image projected by the second light source, FIG. 7C shows an example of a dynamic projected image projected by the third light source, and FIG. 7D is a diagram illustrating an example of when plural projected images projected by the first to third light sources are superimposed.

The control unit 6 switches between the projected images 70 by continuously controlling the turning on and off of the light-emitting elements, thereby projecting a dynamic projected image 70 onto the projected area 7. The dynamic projected image 70 is an image in which the light-shielded image 260, which is the black part formed by the light-shielding region 26, moves as a result of continuously and sequentially switching the projected images 70a to 70c having the first to third designs 21a to 21c, i.e., an animation formed by the projected images 70a to 70c as an example, as shown in FIGS. 7A to 7C. Continuously switching between the projected images 70a to 70c causes the light-shielded image 260 to look as if rotating and moving in the counterclockwise direction as shown in FIGS. 7A to 7C. The number of projected images 70 is changed according to how many projected images 70 the projector 1 can project.

The control unit 6 can also turn on at least two of the first to third light sources 31 to 33 simultaneously to project the projected image 70d that is different from the projected images 70a to 70c. The projected image 70d shown in FIG. 7D is an image formed by superimposing the projected images 70a to 70c and has a fourth design 21d formed by superimposing the first to third designs 21a to 21c, as an example. In addition, the projected image 70d is a superimposed image of plural projected images 70 and thus can be a projected image with depth.

Furthermore, the projector 1 can form the projected image 70 in full color by configuring the light source unit 3 to output red, green, and blue projected lights 30a to 30c.

### Effects of the First Embodiment

The projector 1 in the first embodiment can easily switch the projected image 70. In particular, the projector 1 has the first to third pattern regions 22 to 24 that form different projected images 70a to 70c. Therefore, as compared to when replacing with a member having a different pattern, it is easy to switch between the projected images 70a to 70c by turning on and off the light-emitting elements 31a to 33a of the first to third light sources 31 to 33. In addition, the projector 1 has a simplified structure and can be manufactured at a lower cost as compared to when replacing with a member having a different pattern.

The projector 1 can project the projected image 70d formed by superimposing at least two of the projected images 70a to 70c. Therefore, as compared to when such a configuration is not adopted, the number of types of projected images 70 can be increased without increasing the pattern regions and the projected image 70d with depth can also be projected.

In the projector 1, the first to third condenser lenses 41 to 43 of the condenser lens unit 4 are integrally formed, the first to third pattern regions 22 to 24 of the pattern portion 2 are integrally formed, and the first to third projection lens 51 to 53 of the projection lens unit 5 are integrally formed. In addition, in the projector 1, the condenser lens unit 4, the pattern portion 2 and the projection lens unit 5 are unitized as the first unit 11. Therefore, as compared to when the condenser and projection lenses are formed separately and attached to the housing, misalignment is suppressed and projection position accuracy and brightness of the projected image 70 are improved, allowing a design property to be enhanced.

The projector 1 has the first partition member 105 and the second partition member 106 that separates between the first to third light sources 31 to 33. Therefore, as compared to when such a configuration is not adopted, the respective projected lights of the light sources are not mixed and the projected image 70 with high resolution can be projected.

Since the projector 1 can project the dynamic projected image 70 by continuously switching between plural projected images 70, the design property can be improved as compared to when it is not possible to switch between the projected images.

The projector 1 can project the projected image 70 in full color by outputting the projected lights 30 of plural colors from the light source unit 3. Therefore, as compared to when such a configuration is not adopted, the degrees of freedom in designing the projected image 70 to be projected is improved.

### Second Embodiment

The second embodiment differs from the first embodiment in the configuration of the light source unit.

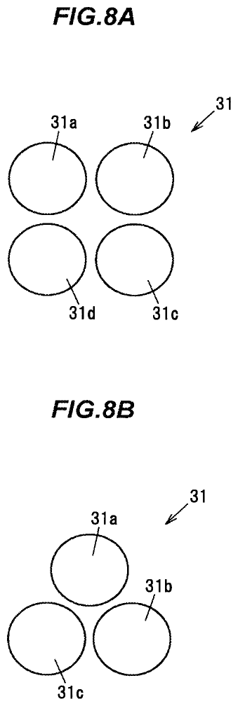

FIG. 8A is a diagram illustrating an example of the light source having four light-emitting elements in the second embodiment, and FIG. 8B is a diagram illustrating an example of the light source having three light-emitting elements. In the embodiment described below, portions having the same functions and configurations as those in the first embodiment are denoted by the same reference signs as those in the first embodiment and the explanation thereof will be omitted.

When the light source is composed of plural light-emitting elements, the control unit 6 controls the turning on and off of the light-emitting elements to cause at least one of an increase/decrease in brightness of the projected image and color change of the projected image.

The Number of Light-Emitting Elements that Constitute the Light Source

The first light source 31 shown in FIG. 8A has light-emitting elements 31a to 31d. The other light sources may have the same configuration as the first light source 31 or may differ from the first light source 31 in the number of light-emitting elements.

The first light source 31 shown in FIG. 8A has the light-emitting elements 31a to 31d. These light-emitting elements 31a to 31d are arranged at the vertices of a square as an example, but it is not limited thereto. The light-emitting elements 31a to 31d project the projected image 70a based on the first pattern region 22 onto the projection area 7. The light-emitting elements 31a to 31d may be configured, e.g., to output light of the same color or to output lights of different colors.

The control unit 6 can control an increase/decrease in brightness of the projected image 70a or color change of the projected image 70a by controlling the turning on and off of each of the light-emitting elements 31a to 31d.

The first light source 31 shown in FIG. 8B has the light-emitting elements 31a to 31c. These light-emitting elements 31a to 31c are arranged at the vertices of a triangle as an example, but it is not limited thereto. The light-emitting elements 31a to 31c may be configured, e.g., to output light of the same color or to output lights of different colors.

The control unit 6 can control an increase/decrease in brightness of the projected image 70a or color change of the projected image 70a by controlling the turning on and off of each of the light-emitting elements 31a to 31c.

When one light source is composed of plural light-emitting elements, the projector 1 may be configured such that the condenser lens has a shape with partially different curvatures to collect the projected light 30 output from the plural light-emitting elements onto the corresponding pattern region and projection lens, or plural condenser lenses corresponding to the light-emitting elements are gathered to form a single condenser lens, but the configuration is not limited thereto. Furthermore, the projector 1 may be configured such that one of the light sources is composed of a larger number of light-emitting elements.

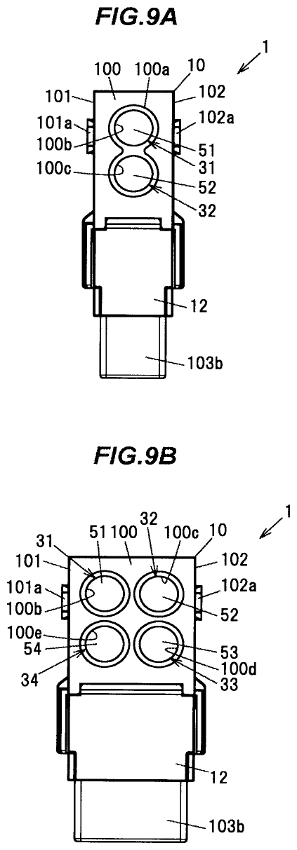

The number of light sources that constitute the light source unit 3 FIG. 9A is a diagram illustrating an example of the light source unit having two light sources in the second embodiment, and FIG. 9B is a diagram illustrating an example of the light source unit having four light sources.

The light source unit 3 shown in FIG. 9A has the first light source 31 and the second light source 32. In this light source unit 3, the first light source 31 and the second light source 32 are aligned vertically, as an example. This projector 1 therefore has two each of the pattern region, condenser lens and projection lens so as to correspond to the first light source 31 and the second light source 32. This projector 1 can project at least two different projected images 70.

The light source unit 3 shown in FIG. 9B has first to fourth light sources 31 to 34. In this light source unit 3, the first to fourth light sources 31 to 34 are arranged at the vertices of a square, as an example. This projector 1 therefore has four each of the pattern region, condenser lens and projection lens so as to correspond to the first to fourth light sources 31 to 34. This projector 1 can project at least four different projected images 70.

Intensity of Brightness of the Projected Image 70

FIGS. 10A to 10C are explanatory diagrams illustrating examples of brightness level of the projected image in the second embodiment. Although the projected image 70a projected by the first light source 31 will be described below as an example, the same applies to the other light sources.

The first light source 31 of the projector 1 has the light-emitting elements 31a to 31c, as an example. For the purpose of explaining the brightness level, the light-emitting elements 31a to 31c of the first light source 31 are assumed to output the projected lights 30a of the same color, as an example.

The projected image 70a shown in FIG. 10A is a projected image of the first pattern region 22 when the control unit 6 causes the light-emitting element 31a to turn on and the light-emitting elements 31b and 31c to be off.

The projected image 70a shown in FIG. 10B is a projected image of the first pattern region 22 when the control unit 6 causes the light-emitting elements 31a and 31b to turn on and the light-emitting element 31c to be off. This projected image 70a has a higher brightness than the projected image 70a shown in FIG. 10A.

Furthermore, the projected image 70a shown in FIG. 10C is a projected image of the first pattern region 22 when the control unit 6 causes the light-emitting elements 31a to 31c to turn on. This projected image 70a has a higher brightness than the projected image 70a shown in FIG. 10B. In this manner, the control section 6 can increase the brightness by increasing the number of light-emitting elements that are on, as shown in FIGS. 10A to 10C.

When the light-emitting elements 31a to 31c output the projected lights 30a of different colors, the control unit 6 can produce color change of the projected image 70a by controlling the turning on and off of the light-emitting elements 31a to 31c in a similar manner.

### Effects of the Second Embodiment

When one light source is composed of plural light-emitting elements, even if the projected image 70 has the same pattern, the projector 1 can project the projected image 70 differently by individually controlling the turning on and off of the plural light-emitting elements and causing an increase/decrease in brightness or color change.

As another embodiment, the projection lens unit 5 may be configured to project plural projected images onto different locations of the projection area 7.

### Third Embodiment

The third embodiment differs from the first embodiment in the form of representation of the image displayed in the projection area by the projector. The explanation for the same features as those in the first embodiment, such as the configuration of the projector, will be omitted or simplified. In addition, portions having the same functions and configurations as those in the first embodiment are denoted by the same reference signs as those in the first embodiment.

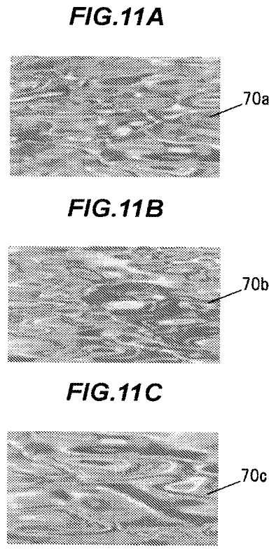

FIG. 11A shows an example of a portion of the projected image 70a projected by the first light source 31 of the projector 1 in the third embodiment, FIG. 11B shows an example of a portion of the projected image 70b projected by the second light source 32, and FIG. 11C shows an example of a portion of the projected image 70c projected by the third light source 33.

As described above, the first light source 31 turns on the light-emitting element 31a and outputs the projected light 30a, based on the first control signal S 1 output from the control unit 6. The second light source 32 turns on the light-emitting element 32a and outputs the projected light 30b, based on the second control signal S₂ output from the control unit 6. The third light source 33 turns on the light-emitting element 33a and outputs the projected light 30c, based on the third control signal S₃ output from the control unit 6.

The control unit 6 controls the turning on and off of the light-emitting elements 31a, 32a and 33a to sequentially project the projected images 70a, 70b and 70c onto the projected area 7, thereby displaying an image that changes with time.

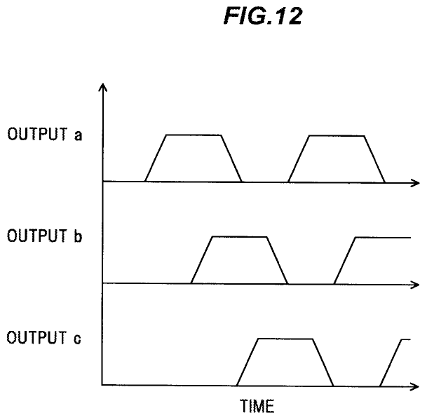

FIG. 12 is an example of a timing chart showing output timings of the light-emitting elements 31a, 32a and 33a. Outputs a, b and c shown in FIG. 12 are respective outputs of the light-emitting elements 31a, 32a and 33a.

As shown in FIG. 12, the output of each of the light-emitting element 31a, 32a and 33a gradually increases when turned on and gradually decreases when turned off. This allows each of the projected images 70a, 70b and 70c to fade in and out when projected.

In addition, as shown in FIG. 12, the timing of output of each of the light-emitting elements 31a, 32a and 33a partially coincides with the timings of output of the light-emitting elements that output therebefore and thereafter. In detail, the timing of output of the light-emitting element 31a partially coincides with the timing of output of the light-emitting element 32a, and the timing of output of the light-emitting element 32a partially coincides with the timing of output of the light-emitting element 33a. The timing of output of the light-emitting element 33a may partially coincide with the timing of next output of the light-emitting element 31a.

As a result, the timing of projecting each of the projected images 70a, 70b and 70c partially coincides with the timing of projecting the projected images projected therebefore and thereafter. That is, the timing of projecting the projected image 70a partially coincides with the timing of projecting the projected image 70b, and the timing of projecting the projected image 70b partially coincides with the timing of projecting the projected image 70c. The timing of projecting the projected image 70c may partially coincide with the timing of projecting the next projected image 70a.

As a result, the image displayed by sequentially projecting the projected images 70a, 70b and 70c shown in FIG. 11 onto the projection area 7 changes with time in a flickering manner. When plural projected images 70 which are similar as a whole or partially to each other in a similar manner to the projected images 70a, 70b and 70c shown in FIG. 11 are sequentially projected onto the projection area 7, the image changes with time in such a manner that the similar portions flicker. That is, the image displayed on the projection area 7 includes a portion that changes in a flickering manner.

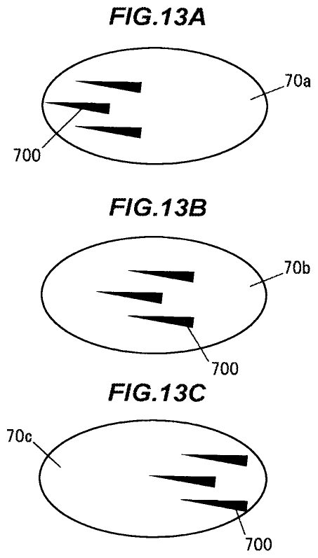

FIG. 13A shows an example of the projected image 70a projected by the first light source 31 of the projector 1 in the third embodiment, FIG. 13B shows an example of the projected image 70b projected by the second light source 32, and FIG. 13C shows an example of the projected image 70c projected by the third light source 33.

The projected images 70a to 70c shown in FIG. 13 each have a specific pattern 700 at a different location.

When controlling the turning on and off of the light-emitting elements 31a, 32a and 33a according to the timing chart shown in FIG. 12, the pattern 700 moves smoothly from left to right in the image which is displayed by sequentially projecting the projected images 70a, 70b and 70c shown in FIG. 13 onto the projected area 7.

When plural projected images 70 having a specific pattern at different locations in a similar manner to the projected images 70a, 70b and 70c shown in FIG. 13 are sequentially projected onto the projected area 7, the image changes with time in such a manner that the specific pattern moves in a specific direction. That is, the image displayed on the projection area 7 includes a portion that moves in a specific direction.

### Effects of the Third Embodiment

An image including a portion which changes in a flickering manner, or an image including a portion which moves smoothly in a particular direction, can be displayed in the projection area 7.

### Fourth Embodiment

The fourth embodiment differs from the first embodiment in that mechanisms to project different projected images are independently provided. The explanation for the same features as those in the first embodiment, such as the configuration of the projector, will be omitted or simplified. In addition, portions having the same functions and configurations as those in the first embodiment are denoted by the same reference signs as those in the first embodiment.

The projector 1 in the first embodiment is a single projector in which the pattern portion 2 having the first to third pattern regions 22 to 24, the light source unit 3 having the first to third light sources 31 to 33, the condenser lens unit 4 having the first to third condenser lenses 41 to 43, the projection lens unit 5 having the first to third projection lens 51 to 53, and the control unit 6 are housed in one housing 10. On the other hand, a projector 8 in the fourth embodiment is composed of plural projectors each capable of projecting the projected image 70 onto the projection area 7.

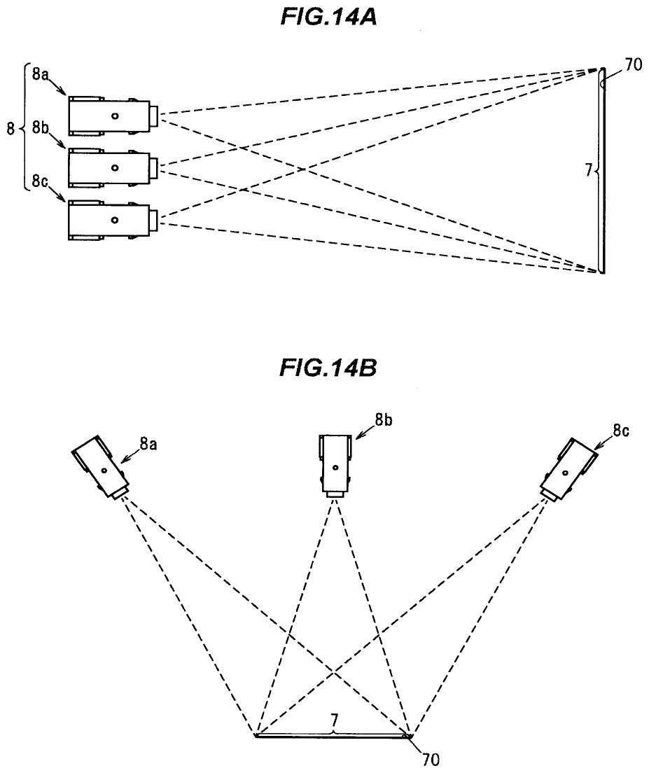

FIGS. 14A and 14B are schematic diagrams each illustrating a state in which a first projector 8a, a second projector 8b and a third projector 8c, which constitute the projector 8 in the fourth embodiment, project the projected image 70 onto the projection area 7.

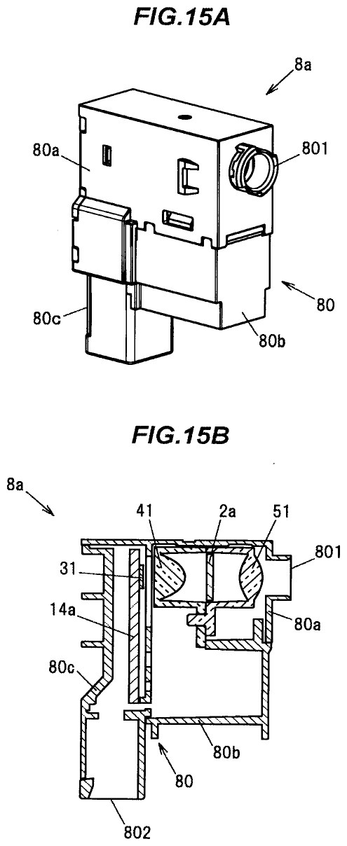

FIGS. 15A and 15B are a perspective view and a vertical cross-sectional view showing the first projector 8a. The first projector 8a includes the first light source 31, a plate-shaped pattern portion 2a having the first pattern region 22, the first condenser lens 41, and the first projection lens 51. A substrate 14a with the first light source 31 mounted thereon, the first condenser lens 41, the first projection lens 51 and the pattern portion 2a are housed in a housing 80 composed of components 80a, 80b and 80c. The housing 80 has an opening 801 to extract light from the first projection lens 51, and an opening 802 to connect a connector of an external device to a connector of the substrate 14a.

In the first projector 8a, a light-emitting element included in the first light source 31, such as the light-emitting element 31a, is turned on and outputs the projected light 30a based on the first control signal S₁ output from the control unit 6. The projected light 30a, which is collected by the first condenser lens 41 and passes through the first pattern region 22 of the pattern portion 2a, is projected onto the projection area 7 by the first projection lens 51 and the projected image 70a is formed.

The second projector 8b has a structure obtained by replacing the first light source 31, the pattern portion 2a, the first condenser lens 41 and the first projection lens 51 of the first projector 8a respectively with the second light source 32, a pattern portion 2b having the second pattern region 23, the second condenser lens 42, and the second projection lens 52.

In the second projector 8b, a light-emitting element included in the second light source 32, such as the light-emitting element 32a, is turned on and outputs the projected light 30b based on the second control signal S₂ output from the control unit 6. The projected light 30b, which is collected by the second condenser lens 42 and passes through the second pattern region 23 of the pattern portion 2b, is projected onto the projection area 7 by the second projection lens 52 and the projected image 70b is formed.

The third projector 8c has a structure obtained by replacing the first light source 31, the pattern portion 2a, the first condenser lens 41 and the first projection lens 51 of the first projector 8a respectively with the third light source 33, a pattern portion 2c having the third pattern region 24, the third condenser lens 43, and the third projection lens 53.

In the third projector 8c, a light-emitting element included in the third light source 33, such as the light-emitting element 33a, is turned on and outputs the projected light 30c based on the third control signal S₃ output from the control unit 6. The projected light 30c, which is collected by the third condenser lens 43 and passes through the third pattern region 24 of the pattern portion 2c, is projected onto the projection area 7 by the third projection lens 53 and the projected image 70c is formed.

In the projector 8 of the fourth embodiment, the control unit 6 is, e.g., included in a control ECU (Electronic Control Unit) mounted on the vehicle 9 and the first to third control signals S₁ to S₃ from the control unit 6 are sent to the first to third projectors 8a to 8c through a cable harness. In this case, the projector 8 may be a device composed of the first to third projectors 8a to 8c and not including the control unit 6, or may be an image projection system that includes the control unit 6 and the first to third projectors 8a to 8c and is installed on the vehicle 9.

The first projector 8a, the second projector 8b and the third projector 8c may be closely arranged side by side as shown in FIG. 14A, or may be distantly arranged as shown in FIG. 14B.

### Effects of the Fourth Embodiment

In the fourth embodiment, plural different projected images 70 can be projected onto the projection area 7 using plural independent projectors.

### Fifth Embodiment

The fifth embodiment differs from the first embodiment in that a projected image or projected images are changed by relatively moving a pattern portion or pattern portions with respect to a light source unit. The explanation for the same features as those in the first embodiment, such as the configuration of the projector, will be omitted or simplified. In addition, portions having the same functions and configurations as those in the first embodiment are denoted by the same reference signs as those in the first embodiment.

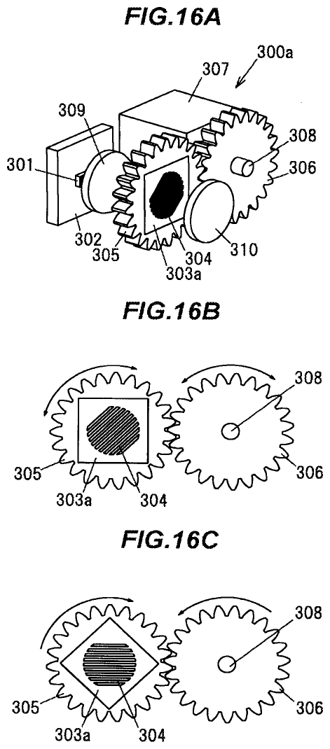

FIG. 16A is a perspective view showing the internal construction of a projector 300a in the fifth embodiment. The projector 300a is comprised of a light source 301 as a light source unit, a substrate 302 with the light source 301 mounted thereon, a plate-shaped pattern portion 303a having a pattern 304, a gear 305 with the pattern portion 303a attached thereto, a gear 306 installed to mesh with the gear 305, an electric actuator 307 with a motor, a rotation shaft 308 of the gear 306 included in the electric actuator 307, a condenser lens 309, and a projection lens 310. These parts are enclosed in a housing similar to the housing 10 of the projector 1.

The light source 301 is provided with at least one light-emitting element similarly to the first to third light sources 31 to 33 mentioned above. The condenser lens 309 has the similar functions to the first to third condenser lenses 41 to 43 mentioned above. The projection lens 310 has the similar functions to the first to third condenser lenses 51 to 53 mentioned above.

The pattern portion 303a is a plate-shaped parts with a pattern 304 having one pattern region which has the similar structure to the pattern portions 2a to 2c mentioned above. The pattern portion 303a is held by the gear 305, for example, by being inserted into a hole having the same form as the pattern portion 303a formed in the gear 305. Alternatively, the pattern portion 303a may be held by being pasted on the surface of the gear 305. In this case, the gear 305 is formed of a material to transmit light emitted from the light source 301.

The gear 305 is rotatably held, for example, by a frame (not shown) covering a part of the outer circumference of the gear 305. Alternatively, the gear 305 may be held by the housing through a rotation shaft formed of a material to transmit light emitted from the light source 301.

As shown in FIG. 16B, when the actuator 307 rotates the gear 306 through the rotation shaft 308, the gear 305 meshing with the gear 306 rotates with the pattern portion 303a so that the in-plane angle of the pattern 304 is changed. For example, as shown in FIG. 16C, when the gear 306 is rotated counterclockwise, the gear 305 rotates clockwise with the pattern portion 303a.

The projector 300a operates as next. The light-emitting element of the light source 301 lights up based on the control signal output from the control unit mounted on the substrate 302 etc. to output the projected light. The projected light is condensed by the condenser lens 309, transmitted through the pattern 304 of the pattern portion 303a, projected on the projection region by the projection lens 310, whereby the projected image is formed. At this time, the projected image is rotated with the rotation of the pattern portion 303a, so as to change over time.

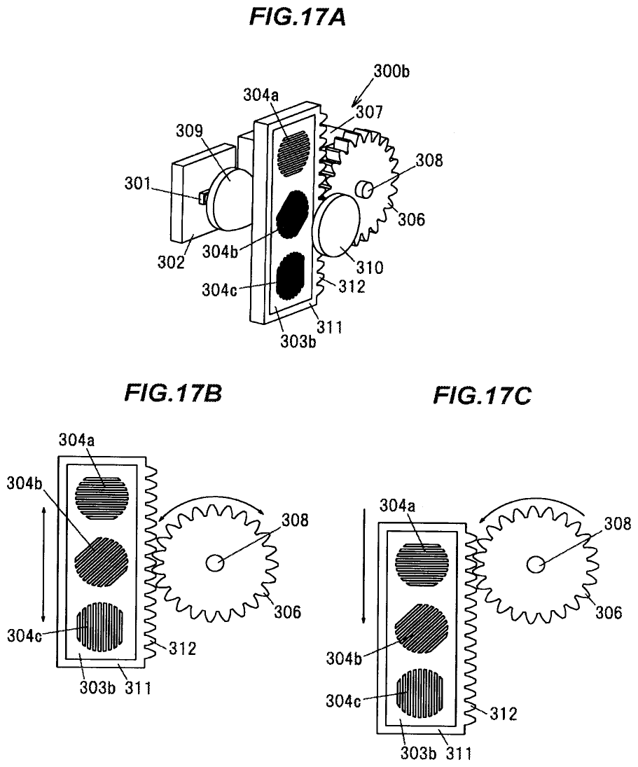

FIG. 17A is a perspective view showing the internal construction of an alternative projector 300b in the fifth embodiment. The projector 300b is comprised of a light source 301 as a light source unit, a substrate 302 with the light source 301 mounted thereon, a plate-shaped pattern portion 303b having a pattern including a first pattern region 304a to a third pattern region 304c, a rectangular retention plate 311 having a concave-convex surface 312 on one side and formed to retain the pattern portion 303b, a gear 306 installed to mesh with the concave-convex surface 312 of the retention plate 311, an electric actuator 307 with a motor, a rotation shaft 308 of the gear 306 included in the electric actuator 307, a condenser lens 309, and a projection lens 310. These parts are enclosed in a housing similar to the housing 10 of the projector 1.

The pattern portion 303b is a plate-shaped parts with a pattern having plural pattern regions (the first pattern region 304a to the third pattern region 304c) which has the similar structure to the pattern portion 2 mentioned above. The first pattern region 304a to the third pattern region 304c in the pattern portion 303b are formed in a line along a predetermined direction. The concave-convex surface 312 of the retention plate 311 is provided on a side of the retention plate 311 along the predetermined direction in which the first pattern region 304a to the third pattern region 304c are formed.

The pattern portion 303b is held by the retention plate 311, for example, by being inserted into a hole having the same form as the pattern portion 303b formed in the retention plate 311. Alternatively, the pattern portion 303b may be held by being pasted on the surface of the retention plate 311. In this case, the retention plate 311 is formed of a material to transmit light emitted from the light source 301. The retention plate 311 is slidably held, for example, by a frame (not shown) covering a side opposite to the side with the concave-convex surface 312 formed thereon.

As shown in FIG. 17B, when the actuator 307 rotates the gear 306 through the rotation shaft 308, the retention plate 311 with the concave-convex surface 312 meshing with the gear 306 slides with the pattern portion 303b in one direction (a vertical direction in FIG. 17B) so that a region of the first pattern region 304a to the third pattern region 304c onto which the projected light is irradiated is changed. For example, as shown in FIG. 17C, when the gear 306 is rotated counterclockwise, the retention plate 311 slides downward with the pattern portion 303b.

The projector 300b operates as next. The light-emitting element of the light source 301 lights up based on the control signal output from the control unit mounted on the substrate 302 etc. to output the projected light. The projected light is condensed by the condenser lens 309, transmitted through the pattern including the first pattern region 304a to the third pattern region 304c of the pattern portion 303b, projected on the projection region by the projection lens 310, whereby the projected image is formed. At this time, the projected image is changed between images corresponding to the first pattern region 304a to the third pattern region 304c with the sliding of the pattern portion 303b, so as to change over time.

In the example shown in FIGS. 17A to 17C the pattern portion 303b is slid while fixing the light source 301 in the projector 300b. However, a region of the first pattern region 304a to the third pattern region 304c onto which the projected light is irradiated may be changed by sliding the light source while fixing the pattern portion 303b. In this case, the substrate 302 with the light source 301 installed thereon is held by the retention plate 311 such that the retention plate 311 is slid with the pattern portion 303b upon rotation of the gear 306. Also, in this case, corresponding to the first pattern region 304a to the third pattern region 304c, respectively, plural condenser lens and projection lens, for example, the first condenser lens 41 to the third condenser lends 43 and the first projection lens 51 to the third projection lens 53 mentioned above are used.

### Effects of the Fifth Embodiment

In the fifth embodiment, the projected images projected onto the projection area can be changed by relatively moving the pattern portion with respect to the light source unit.

According to the first to fifth embodiments, it is possible to provide a projector as defined below.

(A) A projector, comprising: a pattern portion comprising a pattern to be projected onto a projection area; a light source unit that irradiates the pattern with projected light; and a projection lens unit comprising a projection lens that enlarges a design of the pattern in a region irradiated with the projected light and projects the design onto the projection area to form a projected image thereon, wherein an image formed on the projection area is changed by switching the region of the pattern irradiated with the projected light or by changing an in-plane angle of the pattern.

According to the first to fourth embodiments, it is possible to provide a projector as defined below.

(B) The projector defined in (A) above, wherein the light source unit comprises a plurality of light sources each comprising at least one light-emitting element, and wherein the region of the pattern irradiated with the projected light is switched by independently changing an emission state of the plurality of light sources included in the light source unit.

Although some embodiments and modifications of the invention have been described, these embodiments and modifications are merely examples and the invention according to claims is not to be limited thereto. These new embodiments and modifications may be implemented in various other forms, and various omissions, substitutions and changes, etc., can be made without departing from the gist of the invention.

For example, in an embodiment to control the turning on and off of light-emitting elements as plural light sources included in the light source unit to switch between plural projected images, the output (emission intensity) of the light-emitting elements as plural light sources may be controlled so as to switch between plural projected images. That is, the plural projected images can be switched by independently changing the emission state of the plural light sources included in the light source unit. The emission state of the plural light sources included in the light source unit can be controlled by the control unit.

In addition, the constituent elements in the embodiments can be arbitrarily combined without departing from the gist of the invention. Also, not all combinations of the features described in these embodiments and modifications are necessary to solve the problem of the invention. Further, these embodiments and modifications are included within the scope and gist of the invention and also within the invention described in the claims and the range of equivalency.

According to the above embodiments and examples, it is also possible to provide a projector as defined below.

(1) A projector, comprising: a pattern portion comprising a pattern to be projected onto a projection area; a light source unit that comprises a plurality of light sources each comprising at least one light-emitting element and is configured such that the light sources output projected light respectively to different regions of the pattern; a projection lens unit comprising a plurality of projection lenses that are provided so as to correspond to the different regions of the pattern and form a projected image in the projection area by enlarging and projecting the different regions of the pattern that face the projection lenses; and a control unit that controls turning on and off of the light-emitting elements of the light source unit to switch between a plurality of the projected images that correspond to the different regions of the pattern.

(2) The projector defined in (1) above, comprising: a condenser lens unit comprising a plurality of condenser lenses that are arranged for each of the light sources to collect the projected light output from the light source unit.

(3) The projector defined in (2) above, comprising: a partition member that separates between the light sources.

(4) The projector defined in (3) above, wherein the projection lens unit projects a plurality of the projection images onto the same location in the projection area.

(5) The projector defined in (3) above, wherein the projection lens unit projects a plurality of the projection images onto different locations in the projection area.

(6) The projector defined in (4) or (5) above, wherein the control unit continuously controls turning on and off of the light-emitting elements to switch the projected image and project the projected image dynamically onto the projection area.

(7) The projector defined in (4) or (5) above, wherein when the light source comprises a plurality of light-emitting elements, the control unit controls turning on and off of the light-emitting elements to cause at least one of an increase/decrease in brightness of the projected image and color change of the projected image.

### REFERENCE SIGNS LIST

1 PROJECTOR
2 PATTERN PORTION
3 LIGHT SOURCE UNIT
4 CONDENSER LENS UNIT
5 PROJECTION LENS UNIT
6 CONTROL UNIT
7 PROJECTION AREA
9 VEHICLE
10 HOUSING
11 FIRST UNIT
12 FIRST COVER
13 SECOND UNIT
14 SUBSTRATE
15 SECOND COVER
20 TRANSPARENT SUBSTRATE
20a-20c FIRST TO THIRD PATTERN PLATES
21 PATTERN
21a-21c FIRST TO THIRD DESIGNS
22-24 FIRST TO THIRD PATTERN REGIONS
25 TRANSMISSIVE REGION
26 LIGHT-SHIELDING REGION
30, 30a-30c PROJECTED LIGHT
31-34 FIRST TO FOURTH LIGHT SOURCES
31a-31d LIGHT-EMITTING ELEMENT
40a FRONT SURFACE
40b SIDE SURFACE
41-43 FIRST TO THIRD CONDENSER LENSES
50a FRONT SURFACE
50b BACK SURFACE
50c SIDE SURFACE
51-53 FIRST TO THIRD PROJECTION LENSES
70, 70a-70d PROJECTED IMAGE
90 DOOR
91 INSTRUMENT PANEL
92 FLOOR BOX
93 BATHTUB
94, 95 FLOOR
96 CEILING
97 DRIVER'S SEAT
98 FRONT PASSENGER SEAT
99 REAR SEAT
90a-96a INSTALLATION LOCATION
90b-96b PROJECTION POSITION
100 FRONT SURFACE
100a CYLINDER PORTION
100b-100d FIRST TO THIRD LENS OPENINGS
101 LEFT SIDE SURFACE
101a LEFT-SIDE CLAW PORTION
101b LOWER-SIDE FITTING OPENING
101c UPPER-SIDE FITTING OPENING
102 RIGHT SIDE SURFACE
102a RIGHT-SIDE CLAW PORTION
102b LOWER-SIDE FITTING OPENING
102c UPPER-SIDE FITTING OPENING
103 LOWER SURFACE
103a FIRST INSERTION OPENING
103b CONNECTOR PORTION
104 BACK SURFACE
104a SECOND INSERTION OPENING
105 FIRST PARTITION MEMBER
106 SECOND PARTITION MEMBER
120, 121 FITTING CLAW
122 FITTING OPENING
123 ATTACHMENT OPENING
140 SURFACE
141 CONNECTOR PIN
150, 151 FITTING CLAW
152 ATTACHMENT OPENING
200 FRONT SURFACE
201 BACK SURFACE
250 LIGHT-TRANSMITTED IMAGE
260 LIGHT-SHIELDED IMAGE
400 OPENING
401 PROTRUDING PORTION
402 HOLE PORTION
403 CLAW PORTION
500 OPENING
501 PROTRUDING PORTION
502 COLUMNAR PORTION
900 VEHICLE CONTROL UNIT
901 A-PILLAR
902 B-PILLAR
910 DISPLAY DEVICE
700 PATTERN
8 PROJECTOR
8a-8c FIRST TO THIRD PROJECTORS
300a, 300b PROJECTOR
301 LIGHT SOURCE
303a, 303b PATTERN PORTION
304 PATTERN
309 CONDENSER LENS
310 PROJECTION LENS
304a to 304c FIRST PATTERN REGION TO THIS PATTERN REGION

1. A projector, comprising:
a pattern portion comprising a pattern to be projected onto a projection area;
a light source unit that irradiates the pattern with projected light; and
a projection lens unit comprising a projection lens that enlarges a design of the pattern in a region irradiated with the projected light and projects the design onto the projection area to form a projected image thereon,
wherein the projected image formed on the projection area is changed by switching the region of the pattern irradiated with the projected light or by changing an in-plane angle of the pattern.

2. The projector according to claim 1, wherein the light source unit comprises a plurality of light sources each comprising at least one light-emitting element, and wherein the region of the pattern irradiated with the projected light is switched by independently changing an emission state of the plurality of light sources included in the light source unit.

3. The projector according to claim 2, further comprising a control unit that controls the emission state the plurality of light sources included in the light source unit,
wherein the pattern portion, the light source unit and the projection lens unit are housed in one housing.

4. The projector according to claim 3, further comprising a condenser lens unit comprising a plurality of condenser lenses that are arranged for each of the light sources to collect the projected light output from the light source unit.

5. The projector according to claim 4, further comprising a partition member that separates between the light sources.

6. The projector according to claim 2, wherein the projection lens unit projects a plurality of the projection images onto the same location in the projection area.

7. The projector according to claim 2, wherein the projection lens unit projects a plurality of the projection images onto different locations in the projection area.

8. The projector according to claim 2, wherein the control unit continuously controls turning on and off of the light-emitting element to switch the projected image and project the projected image dynamically onto the projection area.

9. The projector according to claim 2, wherein when the light source comprises a plurality of the light-emitting elements, the control unit controls turning on and off of the light-emitting elements to cause at least one of an increase/decrease in brightness of the projected image and color change of the projected image.

10. The projector according to claim 2, wherein a plurality of the projected images are sequentially projected onto the projection area by controlling turning on and off of the light-emitting elements by the control unit to display an image changing with time, and wherein the plurality of projected images are projected in such a manner that each projected image is faded in and faded out and timing of projecting each of the plurality of the projected images partially coincides with timings of projecting the projected images projected therebefore and thereafter.

11. The projector according to claim 10, wherein the image changing with time comprises an image comprising a portion changing in a flickering manner, or an image comprising a portion moving in a specific direction.

12. The projector according to claim 1, wherein, by moving the pattern portion relative to the light source unit, the region of the pattern irradiated with the projected light is switched or the in-plane angle of the pattern is changed.

13. The projector according to claim 12, wherein, by moving the pattern portion while fixing the light source unit in the projector, the region of the pattern irradiated with the projected light is switched or the in-plane angle of the pattern is changed.

14. The projector according to claim 12, wherein, by moving the light source unit while fixing the pattern portion in the projector, the region of the pattern irradiated with the projected light is switched.

15. The projector according to claim 13, wherein the in-plane angle of the pattern is changed by rotating the pattern portion.

16. The projector according to claim 12, wherein, by sliding the pattern portion relative to the light source unit, the region of the pattern irradiated with the projected light is switched.

17. A projector, comprising:
a pattern portion comprising a pattern to be projected onto a projection area;
a light source unit that comprises a plurality of light sources each comprising at least one light-emitting element, each of the light sources outputting projected light to a different region of the pattern;
a projection lens unit comprising a plurality of projection lenses that are installed corresponding to the different region of the pattern, and that enlarges and projects opposing one of the different region of the pattern to form a projected image on the projection area; and
a control unit that controls turning on and off of the light-emitting element of the light source unit to switch a plurality of the projected image corresponding to the different region of the pattern.

18. The projector according to claim 17, further comprising a condenser lens unit comprising a plurality of condenser lenses that are arranged for each of the light sources to collect the projected light output from the light source unit.

19. The projector according to claim 17, further comprising a partition member that separates between the light sources.

20. The projector according to claim 17, wherein the control unit continuously controls turning on and off of the light-emitting element to switch the projected image and project the projected image dynamically onto the projection area.
